(19) United States
(12) Patent Application Publication
(10) Pub. No.: US 2011/0137793 A1
(43) Pub. Date: Jun. 9, 2011

(54) Gift Card Activation Methods and Gift Card Products

(76) Inventor: Charles Franklin Liggett, Madison, NJ (US)

(21) Appl. No.: 12/911,481

(22) Filed: Oct. 25, 2010

Related U.S. Application Data
(63) Continuation of application No. 12/226,550, now abandoned.

(51) Int. Cl. G06Q 40/00; B65D 25/00; G06K 19/00; G06K 19/06; G06F 17/00

(52) U.S. Cl. 705/41; 206/45.29; 235/487; 235/494; 235/380; 235/375

(57) ABSTRACT

A method of activating a gift card at a retail entity is provided. The method includes performing a first transaction based on first data obtained from a closed, empty product; retrieving the gift card from a secure location in the retail entity; reading second data from the gift card through a reader; and transmitting the second data and a value to be assigned to the gift card to a financial database platform. The financial database platform assigns the value to an account resident on the financial database platform associated to the gift card so that the gift card is activated.

### CROSS-REFERENCE TO RELATED APPLICATION

This application is a continuation application of U.S. patent application Ser. No. 12/226,550, filed on Oct. 20, 2008, which is related to, and claims priority in, International Patent Application No. PCT/US2006/015144 filed on Apr. 21, 2006, the disclosures of which are incorporated in their entirety by reference herein.

### BACKGROUND OF THE INVENTION

1. Field of the Invention

The present invention relates to gift cards and, more particularly, to gift card activation methods and gift card products for displaying and holding such gift cards.

2. Description of Related Art

It is has become common to give a paper gift certificates, purchased from a particular store, restaurant or any other retail entity (hereinafter individually and collectively referred to as a “retail entity”), as a gift idea for a birthday or other special occasion. Typically, paper gift certificates are printed with a predetermined monetary value requiring the entity to carry an inventory of such paper gift certificates, which was costly, inconvenient, and the certificates needed to be safeguarded. In addition, since the paper gift certificates had a preset dollar value, purchases of less than that dollar value required the retail entity to pay the surplus back to the user, which is also undesired.

Paper gift certificates can be replaced with a gift card, purchased from the retail entity. The gift card can be loaded or charged with any desired monetary amount, removing the necessity to carry a large inventory of such cards. Moreover, since the gift card has a variable dollar value, the card can be debited for the actual amount of the purchase, allowing the remaining dollar value on the gift card for later use in that retail entity.

Unfortunately, prior gift cards have generally been limited to use at the retail entity that issued the card. Since gift cards are typically gifted by the purchaser to another person, the card is inserted or given in a greeting card or other suitable product (hereinafter “product”). Thus, in addition to the gift card itself, the purchaser also purchases the product to hold the gift card.

Accordingly, there is a need for gift card activation methods and products so as to overcome, mitigate, and/or alleviate one or more of the above mentioned and other deleterious effects of the prior art methods and products.

### BRIEF SUMMARY OF THE INVENTION

The present invention provides methods of gift card activation, gift card products, and kits for such gift cards.

A method of activating a gift card at a retail entity is provided. The method includes performing a first transaction based on first data obtained from a closed, empty product; retrieving the gift card from a secure location in the retail entity; reading second data from the gift card through a reader; and transmitting the second data and a value to be assigned to the gift card to a financial database platform. The financial database platform being configured to assign the value to an account resident on the financial database platform associated to the gift card so that the gift card is activated.

A gift card product for a gift card is also provided.

In some embodiments, the gift card product includes a card holding section having a slit adapted to receive the gift card; an overleaf section secured to the card holding section by a first hinge, the overleaf section having at least one panel hinge so as to envelop the card holding section by folding the overleaf section about the at least one panel hinge; and at least one hanger portion removably attached to the overleaf section, the at least one hanger portion being configured to be separated from the overleaf section.

In other embodiments, the gift card product includes a card holding section having a slit for receipt of the gift card; an overleaf section secured to the card holding section by a first hinge; a panel hinge separating the overleaf section into a first panel and a second; a first hanger depending from and removably attached to the first panel; and a second hanger depending from and removably attached to the second panel, wherein the gift card holding section and overleaf section are held in a folded position by said first and second hangers but are movable to an unfolded position upon removal of the first and second hangers from the first and second panels, respectively.

In still other embodiments, the gift card product includes an activated gift card associated with a value resident on a financial database platform, said activated gift card being associated only to a consumer bearing the card; a card holding section having a slit in which the activated gift card is received; and an overleaf section secured to the card holding section by a first hinge, the overleaf section having at least one panel hinge so that the activated gift card and the card holding section are enveloped by the overleaf section by folding the overleaf section about the at least one panel hinge.

Further, a kit for gift cards is provided. The kit includes an unactivated gift card and an empty gift card product. The gift card product including a card holding section having a slit adapted to receive the gift card and an overleaf section secured to the card holding section by a first hinge, the overleaf section having at least one panel hinge so that the overleaf section envelops the card holding section when folded at the at least one panel hinge.

The above-described and other features and advantages of the present invention will be appreciated and understood by those skilled in the art from the following detailed description, drawings, and appended claims.

### BRIEF DESCRIPTION OF THE DRAWINGS

FIG. 1 illustrates a schematic depiction of an exemplary embodiment of a gift card activation method according to the present disclosure;

FIG. 2 illustrates a plan view of a first embodiment of a greeting card product according to the present disclosure in an open position;

FIG. 3 illustrates the greeting card product of FIG. 2 in a first folded position;

FIG. 4 illustrates the greeting card product of FIG. 2 in a closed, empty position;

FIG. 5 illustrates the greeting card product of FIG. 2 in an open position after removal of the hangers and insertion of a gift card;

FIG. 6 illustrates the greeting card product of FIG. 5 in a first folded position;

FIG. 7 illustrates the greeting card product of FIG. 5 in a closed, full position;

FIG. 8 illustrates a plan view of a second embodiment of a greeting card product according to the present disclosure in an open position;

FIG. 9 illustrates the greeting card product of FIG. 8 in a first folded position;

FIG. 10 illustrates the greeting card product of FIG. 8 in a second folded position;

FIG. 11 illustrates the greeting card product of FIG. 8 in a closed, empty position;

FIG. 12 illustrates the greeting card product of FIG. 8 in an open position after removal of the hangers and insertion of a gift card;

FIG. 13 illustrates the greeting card product of FIG. 12 in a first folded position;

FIG. 14 illustrates the greeting card product of FIG. 12 in a second folded position; and

FIG. 15 illustrates the greeting card product of FIG. 5 in a closed, full position.

### DETAILED DESCRIPTION OF THE INVENTION

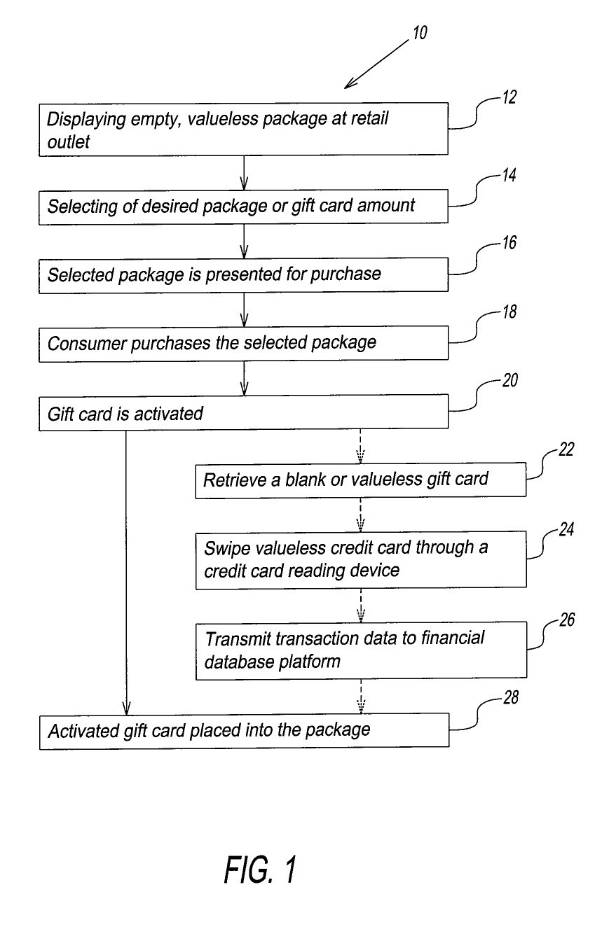

Referring to the drawings and in particular to FIG. 1, an exemplary embodiment of a method for activating a gift card according the present disclosure is generally represented by reference numeral 10.

Method 10 allows the consumer to select a gift card having a predetermined value or amount and/or allows the consumer to select any desired value or amount to be loaded onto the gift card. In addition, method 10 provides the gift card in a product that also can be used as a greeting card.

Importantly, method 10 can, in some embodiments, provide a gift card that is not limited to any particular retailer. Rather, method 10 provides a gift card that, much like a typical credit card, is associated only to the consumer bearing the card.

Method 10 includes a product display step 12, a product selection step 14, a product presentation step 16, a purchase step 18, and a gift card activation step 20.

During product display step 12, the retail entity displays a closed, empty product in the store. The closed product is empty in that it does not yet include the gift card therein. Rather, the gift card is available at the point-of-sale (POS) as will be described below. As such, the product displayed within the retail entity is inherently valueless, which is useful in preventing loss due to theft.

In one embodiment where the product is used to present gift cards of a predetermined monetary value, the closed product includes printed indicia on an exterior of the product, which indicates to the consumer the predetermined monetary value. In this manner, method 10 allows the consumer to select the desired empty, closed product during product selection step 14. In another embodiment where the product has no preset monetary value, the product can include indicia on the product, which allows the monetary value assigned to the gift card to be filled in by the consumer and/or the retail entity.

In addition, the closed product preferably includes indicia printed on the exterior and/or an interior of the product can be used as a greeting card. For example, the indicia can include information that represents, for example, a particular holiday or occasion. Thus, method 10 allows the product to also be used as a greeting card.

Once selected, the consumer presents the empty product to the retail entity's cash register and/or point-of-sale (POS) during purchase step 18. During purchase step 18, the retail entity scans a universal product code (UPC) present on an exterior of the product. The retail entity's computer system associates the UPC with the price of the product, which typically represents the predetermined value of the gift card plus any retailer markup and product value (e.g., as a greeting card). The retail entity receives payment from the consumer for the resultant price.

Next, the retail entity activates a gift card during gift card activation step 20. More particularly, the retail entity retrieves 22 a blank or valueless gift card from a secure location, such as the cash register located at the point-of-sale. The retailer then activates the gift card by, for example, swiping 24 the magnetic strip on the valueless gift card through a credit card reading device typically present at the point-of-sale. The credit card reading device transmits 26 the transaction data (i.e., a unique code present on the swiped gift card and the amount to be loaded on the gift card) to a financial database platform in a known manner.

It should be recognized that the swiping step 24 is disclosed above by way of example only as swiping a magnetic strip on the valueless gift card through a credit card reading device. Of course, it is contemplated by the present disclosure for the gift card to include any machine readable element, such as but not limited to, a magnetic strip, a printed bar code, a radio frequency ID tag, and any combinations thereof.

Upon receipt of the transaction data, the financial database platform activates an account associated with the gift card in the requested amount. Method 10 is described above by way of example in use with a gift card having a predetermined value.

Of course, it is contemplated by the present disclosure for method 10 to find equal use when allowing the consumer to select any desired monetary value or amount to be loaded onto the gift card. Here, during purchase step 18, the retail entity scans the UPC code, which is associated in the retail entity's computer system with the price of the product and any mark-up, but allows the retail entity to add the consumer desired value of the gift card.

After activation step 20, method 10 can include an enveloping or wrapping step 28. During wrapping step 28, the retailer or consumer can insert or place the gift card back into the product and close the product around the gift card. Here, the product now advantageously functions as a greeting card for subsequent gifting of the gift card.

The consumer or person to whom the consumer gives the gift card can make purchases using the card by simply using the gift card as a credit or pin-less debit card. More particularly, the consumer can make a transaction request by simply swiping the gift card at any store or entering the account number present on the gift card into any Internet payment program. Transaction requests are approved by the financial database platform when sufficient funds are present in the account corresponding to the gift card. The purchase amount is transferred by the financial database platform from the gift card account to the store at which the purchase occurred and the account associated with the gift card platform is decremented.

In some embodiments, the monetary value present on the gift card can be recharged or increased by, for example, returning to a participating retail outlet.

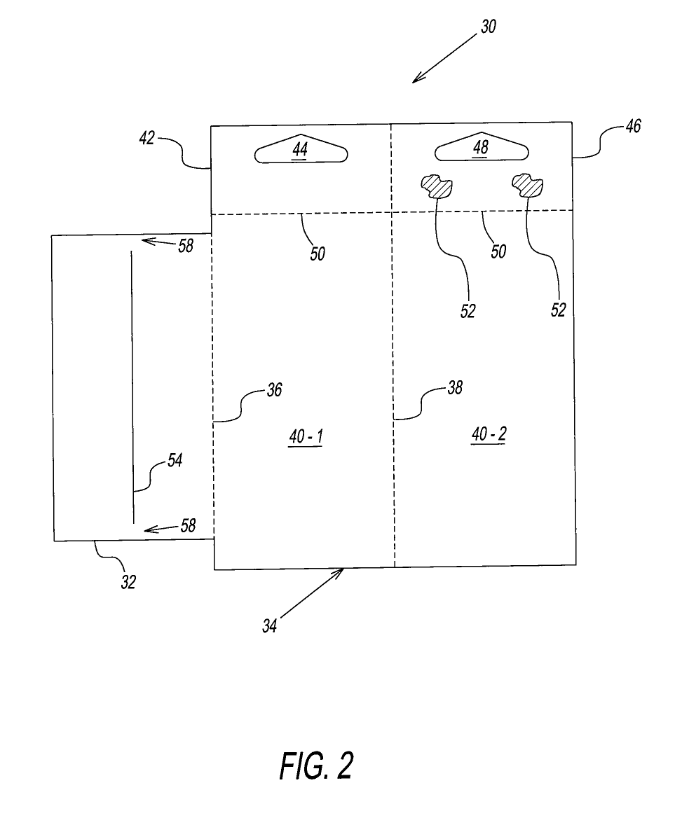

Referring now to FIGS. 2-7, a first embodiment of a gift card product 30 according to the present disclosure for use with method 10 is shown. Advantageously, gift card product 30 is used during product display step 12 to allow the retail entity to display the closed, empty product for use at product selection step 14. In addition, gift card product 30 is configured for use during purchase step 18, wrapping step 28, and can function as a greeting card for subsequent gifting of the gift card.

Product 30 includes a card holding section 32 and an overleaf section 34. Card holding section 32 is secured to overleaf section 34 by a first hinge 36. Overleaf section 34 can include one or more panel hinges 38 (only one shown) so as to envelop a gift card when inserted in the card holding section. In the illustrated embodiment, overleaf section 34 includes one panel hinge 38 separating the overleaf section into a first panel 40-1 and a second panel 40-2.

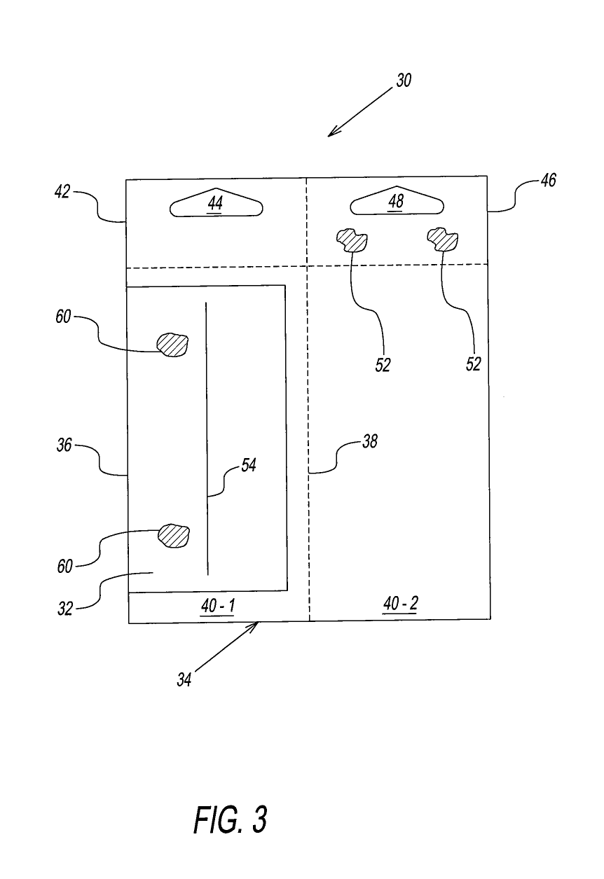

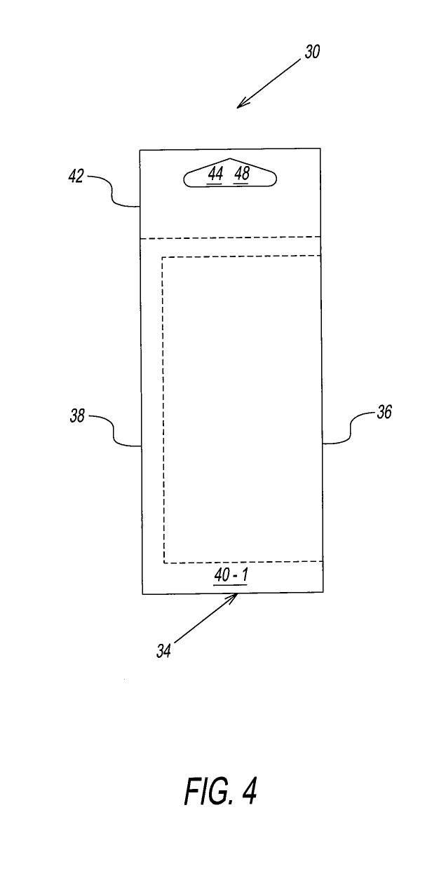

As discussed above with respect to method 10, product 30 is displayed empty. Thus, for purposes of display, product 30 is first folded about first hinge 36 as shown in FIG. 3, then folded about panel hinge 38 as shown in FIG. 4.

Overleaf section 34 includes one or more hangers defined thereon to allow product 30 to be displayed in the retail entity. In the illustrated embodiment, first panel 40-1 includes a hanger 42 including an aperture 44 defined therein, while second panel 40-2 includes a hanger 46 including an aperture 48 defined therein. Product 30 includes a score or tear line 50 defined through overleaf section 34 to allow the hangers 42, 46 to be easily separated from the product. Preferably, tear line 50 represents a weakened area of overleaf section 34, which allows the hangers to be removed from the panels. In the folded position of FIG. 4, apertures 44, 48 are substantially co-axial to one another.

Product 30 is secured in the folded position of FIG. 4 using an adhesive 52. Preferably, adhesive 52 is positioned between hanger 42 and hanger 46. In this manner, product 30 can be opened (i.e., unfolded about panel hinge 38 then first hinge 36) by simply removing hangers 42, 46 along tear line 50. In some embodiments, adhesive 52 is a permanent adhesive that does not allow opening of product 30 without separation of the hangers from the panels along tear line 50.

In a preferred embodiment, product 30 is die cut made of from a single sheet, such as of paper or cardboard. In this embodiment, hinges 36, 38 are living hinges and tear line 50 is a score line, all of which are defined in the single sheet.

Product 30 can include indicia disposed on any surface of card holding section 32, overleaf section 34, and any combinations thereof. Preferably, product 30 includes indicia so that the product is suitable for use as a greeting card, particularly after removal of hangers 42, 46. In addition, it is preferred that product 30 includes a universal product code (not shown) printed on an exterior of the folded product so that the product can easily be used with method 10.

In use with method 10, the folded empty product 30 is displayed in a retail outlet or entity by suspending the empty product from a peg (not shown) through apertures 44, 48. The consumer selects product 30 and brings the empty product to the point-of-sale within the retail outlet, where the gift card is activated in the manner discussed above.

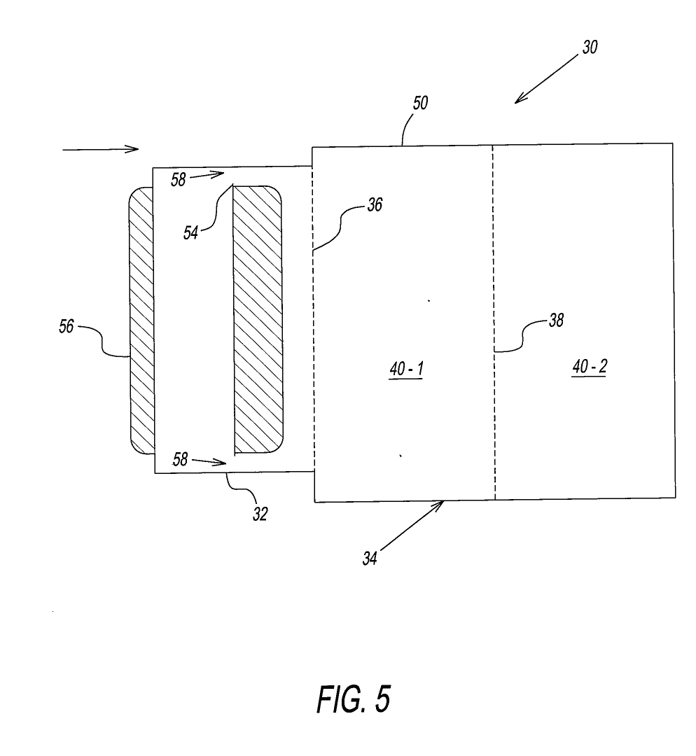

Next, product 30 is opened by removing hangers 42, 46 and unfolding the product about panel hinge 38 then first hinge 36 and a gift card 56 is inserted into the product as shown in FIG. 5. Card holding section 32 includes a slit 54 defined therethrough to allow receipt of a gift card 56. Slit 54 traverses only a portion of the length section 32 so that portions 58 remain to ensure gift card 56 is restrained by the section.

Of course, it should be recognized that product 30 is configured so that gift card 56 can be inserted into slit 54 by unfolding the product about panel hinge 38, and without unfolding the product about first hinge 36.

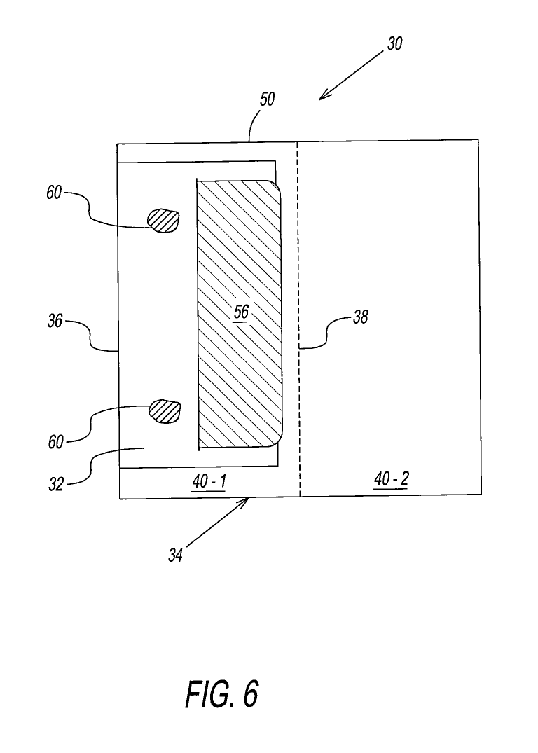

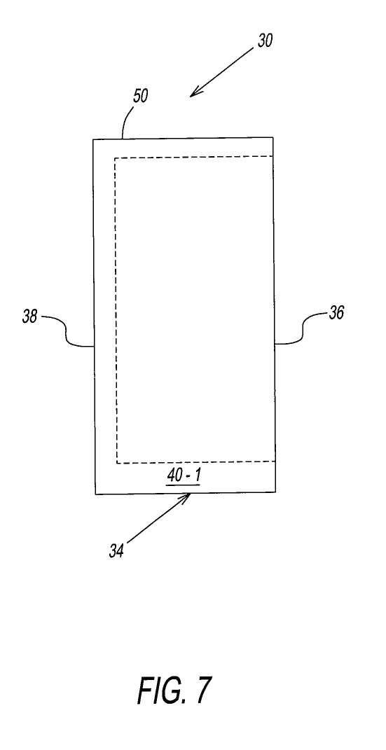

After gift card 56 is positioned in card holding section 32, product 30 is first folded about first hinge 36 as shown in FIG. 6, then folded about panel hinge 38 to result as shown in FIG. 7.

Product 30 is secured in the folded position of FIG. 7 using a re-sealable adhesive 60 seen in FIG. 6. Preferably, adhesive 60, in the folded position is positioned between card holding section 32 and a portion of overleaf section 34, sich as second panel 40-2. In this manner, product 30 can be opened (i.e., unfolded about panel hinge 38 then first hinge 36) without damage to either card holding section 32 or overleaf section 34.

Advantageously, product 30 allows method 10 of the present disclosure to display the product empty, yet allows the product to be opened, the gift card to be inserted and held in place, allows the folded product to then be given as a greeting card.

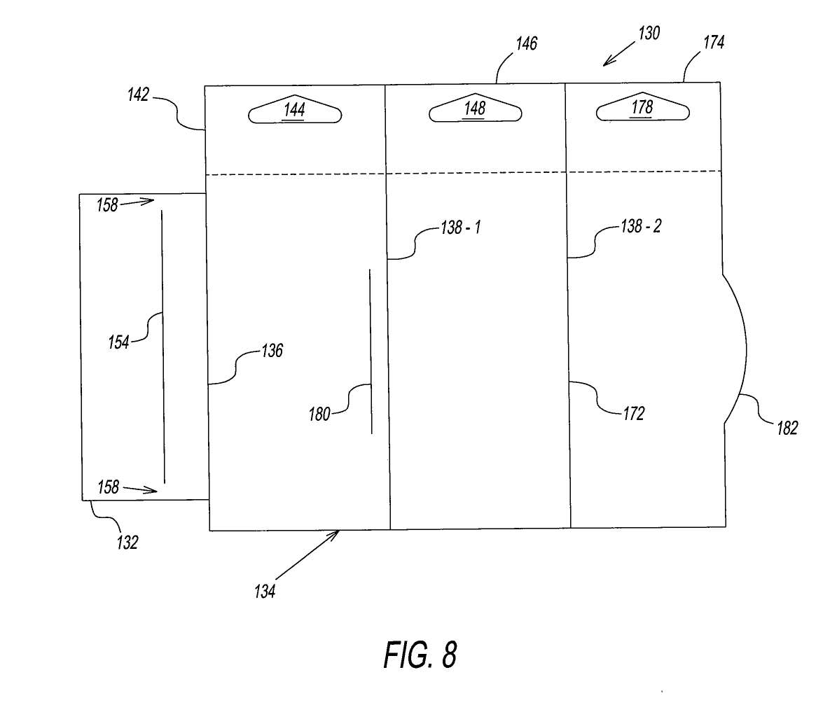

Referring now to FIGS. 8-15, another embodiment of a greeting card product 130 according to the present disclosure for use with method 10 is shown. In this embodiment, component parts performing similar and/or analogous functions to those of the embodiment of FIGS. 2-7 are labeled in multiples of one hundred.

Product 130 includes a card holding section 132 and an overleaf section 134. Card holding section 132 is secured to overleaf section 134 about a first hinge 136. In this embodiment, overleaf section 134 includes two panel hinges 138-1 and 138-2 so as to envelop or wrap a gift card when inserted in the card holding section. In the illustrated embodiment, overleaf section 134 includes two panel hinges 138-1, 138-2 separating the overleaf section into a first panel 140-1, a second panel 140-2, and a third panel 140-3.

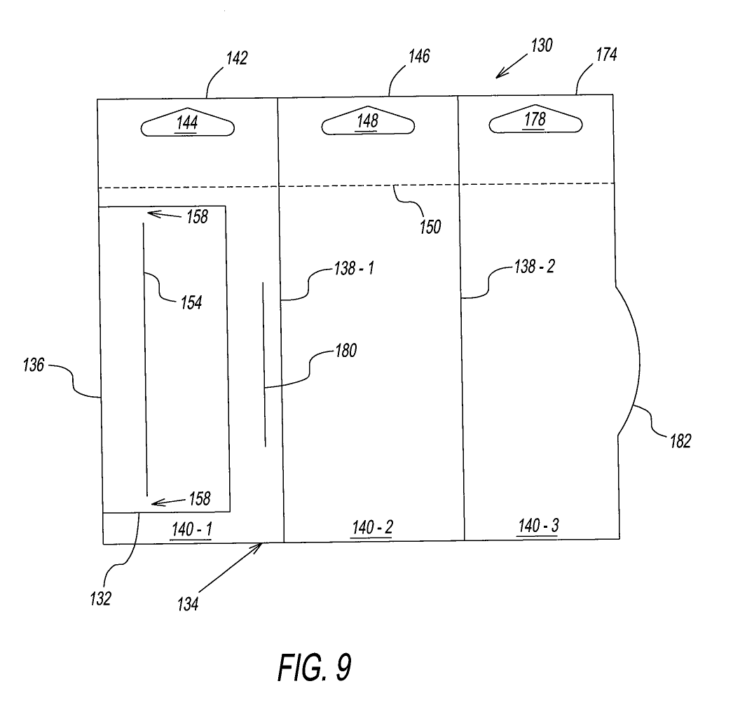

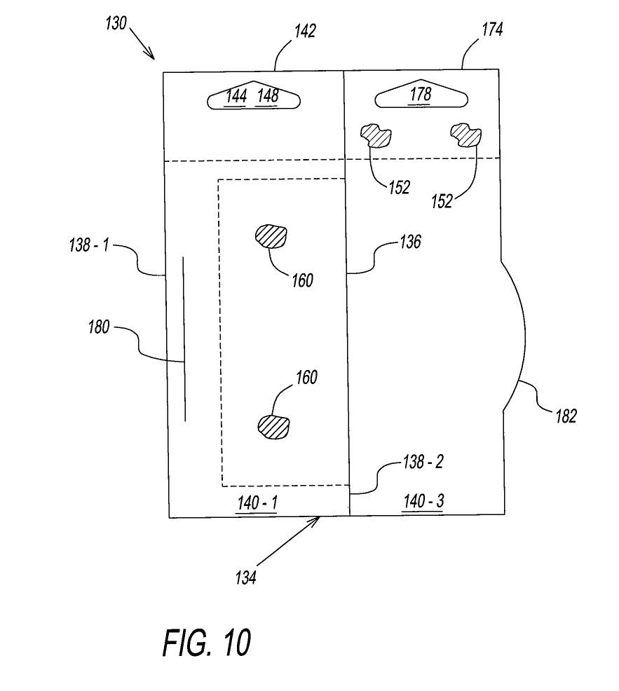

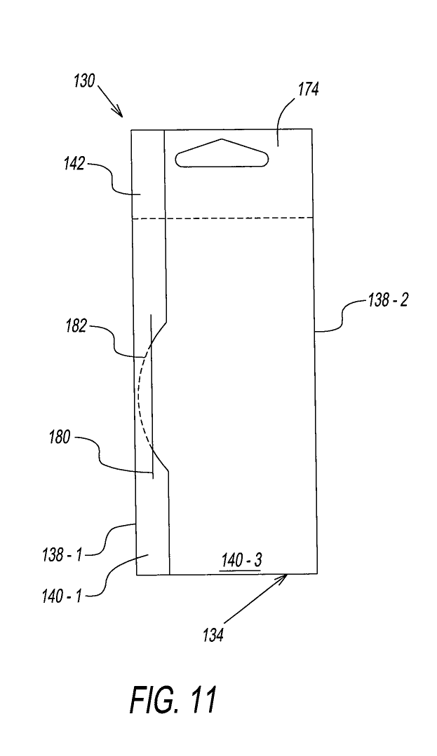

As discussed above with respect to method 10, product 130 is displayed empty. Thus, for purposes of display, product 130 is first folded about first hinge 136 as shown in FIG. 9, folded about panel hinge 138-1 as shown in FIG. 10, then folded about panel hinge 138-2 as shown in FIG. 11.

Overleaf section 134 includes one or more hangers defined thereon to allow product 130 to be displayed in the retail entity. In the illustrated embodiment, first panel 140-1 includes a hanger 142 including an aperture 144 defined therein, second panel 140-2 includes a hanger 146 including an aperture 148 defined therein, and third panel 140-3 includes a hanger 174 including an aperture 178 defined therein. In the folded position of FIG. 11, apertures 144, 148, 178 are substantially co-axial to one another.

Product 130 includes a score or tear line 150 defined through overleaf section 134 to allow the hangers to be easily separated from the product. Preferably, tear line 150 represents a weakened area of product 130, which allows the hangers to be removed from the panels.

Product 130 can be secured in the folded position of FIG. 11 using an permanent adhesive 152 on at least hangers 142, 174 so that the product can be opened by simply removing the hangers along tear line 150.

Product 130 can also be secured in the folded position of FIG. 11 using a tab and slot arrangement. For example, first panel 140-1 can include a slot 180 defined therein and third panel 140-3 can include a tab 182 defined thereon. Slot 180 and tab 182 are positioned so that, in the folded position, at least a portion of the tab is received in the slot.

In a preferred embodiment, product 130 is die cut made of from a single sheet, such as of paper or cardboard. In this embodiment, hinges 136, 138 are living hinges and tear line 150 is a score line, all of which are defined in the single sheet.

Product 130 can include indicia disposed on any surface of card holding section 132, overleaf section 134, and any combinations thereof. Preferably, product 130 includes indicia so that the product is suitable for use as a greeting card, particularly after removal of hangers 142, 146, 174.

In use with method 10, the folded empty product 130 is displayed in a retail outlet by suspending the product from a peg through apertures 144, 148, 178. The consumer selects product 130 and brings the empty product to the point-of-sale, where the gift card is activated in the manner discussed above.

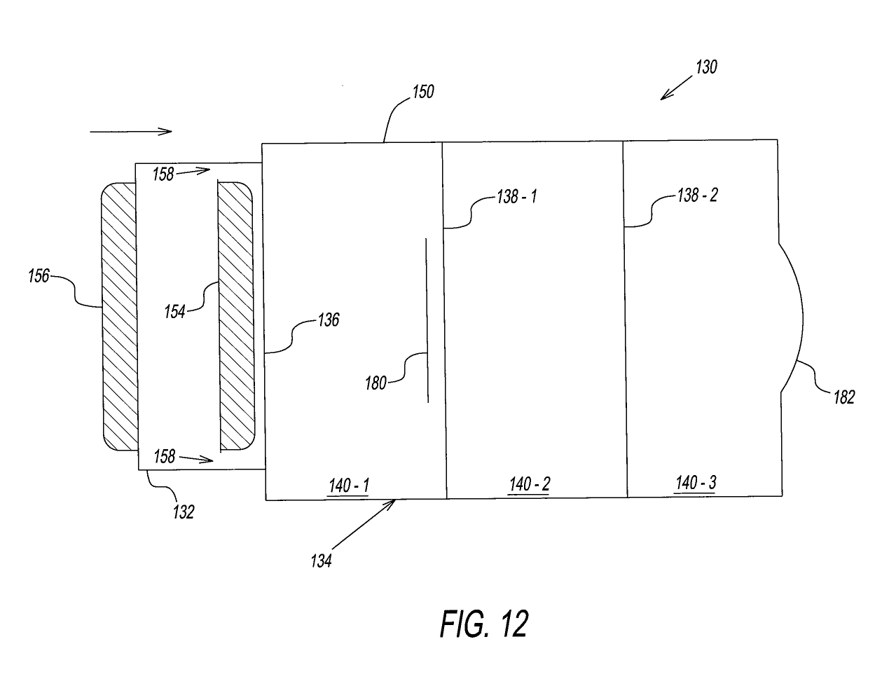

Next, product 130 is opened by removing hangers 142, 146, 174, removing tab 182 from slot 180 and unfolding the product about hinges 136, 138 as shown in FIG. 12. Once opened, a gift card 156 can be inserted into a slit 154 defined through section 132. Slit 154 traverses only a portion of the length section 132 so that portions 158 remain to ensure gift card 156 is restrained by the section.

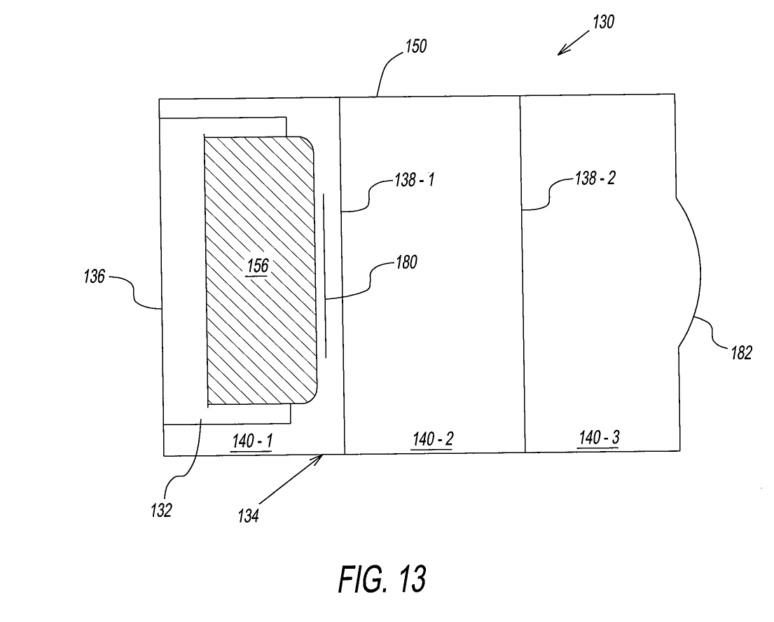

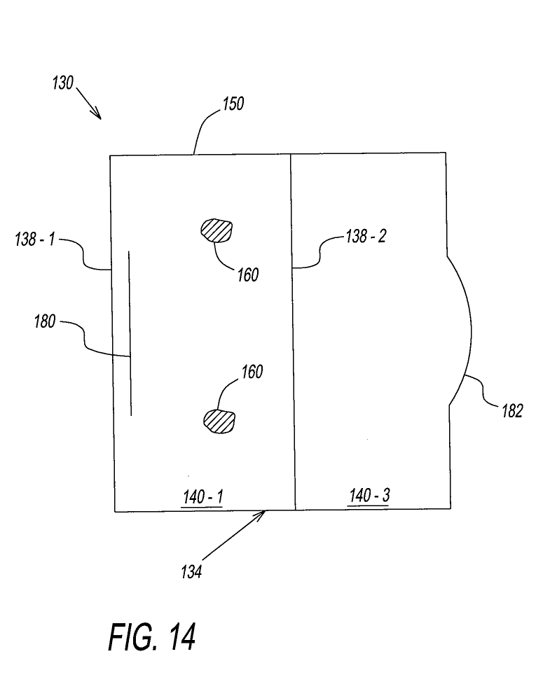

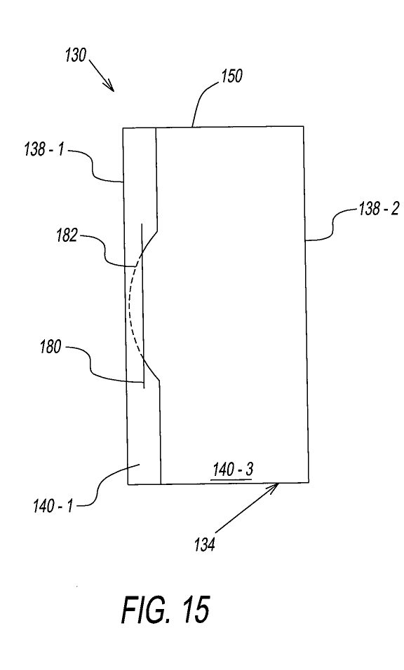

After gift card 156 is positioned in section 132, product 130 is first folded about first hinge 136 as shown in FIG. 13, folded about panel hinge 138-1 as shown in FIG. 14, then folded about panel hinge 138-2 as shown in FIG. 15. Product 130 is secured in the folded position of FIG. 15 by inserting at least a portion of tab 182 is received in slot 180. In this manner, product 130 can be re-opened without damage to either card holding section 132 or overleaf section 134.

In addition, product 130 can, in some embodiments, also be secured in the folded position of FIG. 15 using a re-sealable adhesive 160 seen in FIGS. 10 and 14. Preferably, adhesive 160, when product 130 is in its folded position, is positioned between first panel 140-1 and third panel 140-3.

Advantageously, product 130 allows method 10 of the present disclosure to display the product empty, yet allows the product to be opened, the gift card to be inserted and held in place, allows the folded product to then be given as a greeting card.

It is contemplated by the present disclosure for the unactivated gift card and the gift card product to be sold together in kit form.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method of activating a gift card at a retail entity, comprising the steps of:
performing a first transaction based on first data obtained from an empty product;
retrieving the gift card from a secure location in the retail entity;
reading second data from the gift card through a reader; and
transmitting the second data and a value to be assigned to the gift card to a financial database platform, the financial database platform being configured to assign the value to an account resident on the financial database platform associated to the gift card so that the gift card is activated.

2. The method as in claim 1, wherein the value is based on the first data.

3. The method as in claim 1, wherein the step of reading the second data from the gift card comprises reading a machine readable element on the gift card, the machine readable element being selected from the group consisting of a magnetic strip, a printed bar code, an radio frequency ID tag, and any combinations thereof.

4. The method as in claim 1, wherein the reader is a credit card reader.

5. The method as in claim 1, further comprising the step of opening the empty product and placing the activated gift card therein.

6. The method as in claim 5, further including the step of closing the opened product around the activated gift card whereby the product is useable as a greeting card.

7. The method as in claim 1, wherein the step of performing the first transaction comprises scanning a product code present on an exterior of the empty product.

8. The method as in claim 10, wherein the product code is a universal product code label.

9. A gift card product for a gift card, comprising:
a card holding section having a slit adapted to receive the gift card;
an overleaf section secured to the card holding section by a first hinge, the overleaf section having at least one panel hinge so as to envelop the card holding section by folding the overleaf section about the at least one panel hinge; and
at least one hanger portion removably attached to the overleaf section, the at least one hanger portion being configured to be separated from the overleaf section.

10. The gift card product as in claim 9, wherein the at least one hanger portion comprises a first hanger and a second hanger.

11. The gift card product as in claim 10, further comprising a permanent adhesive for securing the first hanger to the second hanger.

12. The gift card product as in claim 11, further comprising a re-sealable adhesive configured to be positioned between the card holding section and the overleaf section, the re-sealable adhesive being adapted to releaseably hold the card holding section and overleaf section to one another after removal of the first hanger and/or the second hanger.

13. The gift card product as in claim 10, further comprising an aperture defined in each of the first and second hangers, the apertures being configured to be substantially aligned with one another when the card holding section is enveloped by the overleaf section.

14. The gift card product as in claim 9, wherein the card holding section, the overleaf section, and the at least one hanger portion are integrally formed from a single sheet of material.

15. The gift card product as in claim 9, further comprising indicia disposed on any surface of the card holding section, the overleaf section, the at least one hanger portions, and any combinations thereof.

16. A kit for a gift card, comprising:
an unactivated gift card; and
an empty gift card product, the gift card product including a card holding section having a slit adapted to receive the gift card and an overleaf section secured to the card holding section by a first hinge, the overleaf section having at least one panel hinge so that the overleaf section envelops the card holding section when folded at the at least one panel hinge.

17. The kit as in claim 16, further comprising a product code present on an exterior of the empty gift card product.

18. The kit as in claim 17, wherein the product code is a universal product code label.

19. The kit as in claim 16, wherein the product code is representative of a price of the kit.

20. The kit as in claim 19, wherein the price of the kit includes a predetermined value of the gift card and a retailer markup.
